(19) United States
(12) Patent Application Publication
(10) Pub. No.: US 2026/0366349 A1
(43) Pub. Date: Nov. 19, 2026

(54) DOUBLE-JOINTED GATE HINGE

(71) Applicant: Lance W. HINSON, Mount Pleasant, TX (US)

(72) Inventor: Lance W. HINSON, Mount Pleasant, TX (US)

(21) Appl. No.: 19/210,942

(22) Filed: May 16, 2025

(51) Int. Cl. E05D 3/08; E05D 5/02; E06B 11/02

(52) U.S. Cl. CPC E05D 3/08; E05D 5/023; E06B 11/022

(57) ABSTRACT

A gate hinge apparatus comprising a first set of hinge elements and a second set of hinge elements. The first set of hinge elements is configured to connect to a first structure. The second set of hinge elements, spaced apart from the first set of hinge elements, is configured to connect to a second structure. The first set of hinge elements defines a first axis of rotation and the second set of hinge elements defines a second axis of rotation different from the first axis of rotation. The gate hinge apparatus also comprises a body connecting the first set of hinge elements to the second set of hinge elements. The body comprises a vertical member and support arms extending from the vertical member. The first set of hinge elements is disposed on the support arms and the second set of hinge elements is disposed on the vertical member.

### TECHNICAL FIELD

The present disclosure relates in general to the field of gates, and more particularly to a novel gate hinge apparatus for improved rotation of a gate about a support post, as well as a system and methods of use.

### BACKGROUND

Farm gates are sturdy planar structures used to provide access to fenced farms or agricultural property. Farm gates are typically cantilever gates, wherein one end of the gate is rotatably mounted to a vertical support post and the other end of the gate hangs freely. Farm gates may be opened by rotating the gate about the support post. The range of rotation, and therefore the degree to which the gate can be opened, is often limited by the dimensions of the support post. Accordingly, maximally opened farm gates typically at least partially block the passageway, thereby impeding access to the fenced property.

Furthermore, farm gates, typically ranging from 10 to 20 feet in length and often constructed from heavy materials like metal or wood, are prone to structural issues when used in a cantilever system. For example, farm gates often experience bending or deflection due to the weight at the unsupported free end of the gate. Over time, this deflection can lead to permanent deformation or material failure of the gate. This deflection can also cause misalignment of locking mechanisms disposed on the free end of the gate, preventing proper closure and securing of the gate. Furthermore, the weight of the unsupported end of the gate can place excessive stress on the mechanisms by which the gate is attached to a support. This can result in misalignment and failure of the attachment mechanism, thereby compromising the functionality of the gate.

What is needed in the art is a gate hinge that provides an improved range of rotation and weight distribution for an attached gate. To this end, the present disclosure provides a gate hinge with two axes of rotation and distributed support.

### SUMMARY

Novel aspects of the present disclosure are directed to an apparatus comprising a first set of hinge elements configured to connect to a first structure and a second set of hinge elements configured to connect to a second structure, wherein the second set of hinge elements is spaced apart from the first set of hinge elements. The apparatus may also comprise a body connecting the first set of hinge elements to the second set of hinge elements, wherein the body comprises a vertical member and support arms extending from the vertical member. The first set of hinge elements defines a first axis of rotation and the second set of hinge elements defines a second axis of rotation that is different from the first axis of rotation.

In another embodiment, novel aspects of the disclosed principles are directed to an assembly comprising a first structure, a second structure, and a gate hinge pivotally joining the first structure to the second structure. The gate hinge comprises a first set of hinge elements configured to connect to a first structure and a second set of hinge elements configured to connect to a second structure, wherein the second set of hinge elements is spaced apart from the first set of hinge elements. The apparatus may also comprise a body connecting the first set of hinge elements to the second set of hinge elements, wherein the body comprises a vertical member and support arms extending from the vertical member. The first set of hinge elements defines a first axis of rotation and the second set of hinge elements defines a second axis of rotation that is different from the first axis of rotation.

Other aspects, embodiments, and features of the disclosed principles will become apparent from the following detailed description when considered together with the accompanying figures. In the figures, each identical or substantially similar component that is illustrated in various figures is represented by a single numeral or notation. For the purposes of clarity, not every component is labeled in every figure. Nor is every component of each embodiment of the disclosed principles shown where illustration is not necessary to allow those of ordinary skill in the art to understand the principles disclosed herein.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, in which:

FIG. 1 illustrates an isometric front view of one embodiment of a gate hinge designed and constructed in accordance with the disclosed principles;

FIG. 2 illustrates an isometric front view of an exemplary embodiment of a gate hinge coupled to a support and a gate in accordance with the disclosed principles;

FIG. 3 illustrates an isometric front view of an exemplary embodiment of a gate hinge in accordance with the disclosed principles;

FIG. 4 illustrates an isometric front view of an exemplary embodiment of a gate hinge coupled to a support and a gate, wherein the gate is rotated about a first axis of rotation in accordance with the disclosed principles;

FIG. 5 illustrates an isometric angled side view of an exemplary embodiment of a gate hinge coupled to a support and a gate, wherein the gate is rotated about a second axis of rotation in accordance with the disclosed principles;

FIG. 6 illustrates an isometric front view of an exemplary embodiment of a gate hinge in accordance with the disclosed principles; and

FIG. 7 illustrates an isometric front view of an exemplary embodiment of a gate hinge in accordance with the disclosed principles.

INDEX OF REFERENCE NUMERALS AND DEFINITIONS

| Reference | Element |
|---|---|
| 100 | gate hinge apparatus or apparatus |
| 102 | body |
| 104 | vertical member |
| 106A | first support arm |
| 106B | second support arm |
| 108A | first hinge pin |
| 108B | second hinge pin |
| 110A | first hinge barrel |
| 110B | second hinge barrel |
| 112 | opening |
| 202 | gate |
| 204 | gate hinge barrel |
| 206 | support post |
| 208 | support hinge pin |
| 210 | first axis of rotation |
| 212 | second axis of rotation |
| 702 | latch |

### DETAILED DESCRIPTION

Farm gates may be mounted to the vertical support post by a variety of methods. For example, a user may couple the gate to the support post by wrapping chain or wire around the support post and a portion of the gate. Alternatively, a gate may be hinge-coupled to a support post with a portion of the hinge disposed on the gate and a portion of the hinge disposed on the support post. With either of these attachment means, the range of rotation, and therefore the degree to which the gate can be opened, is often limited by the dimensions of the support post. Accordingly, farm gates often block the passageway and impede access to the fenced property.

Novel aspects of this disclosure recognize the need for a gate hinge with an improved range of rotation. To this end, an improved gate hinge apparatus is provided that can provide a full range of rotation around a support structure.

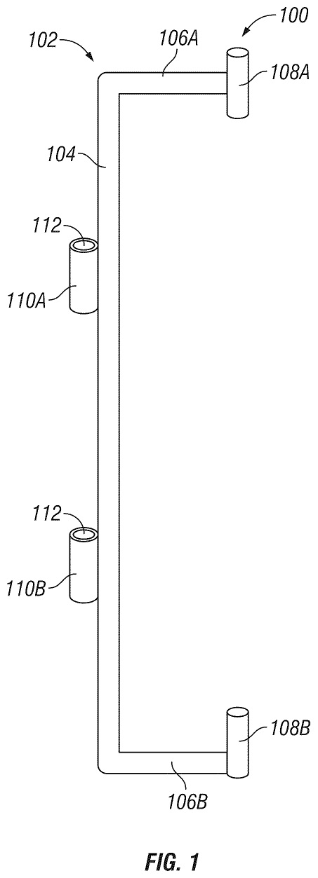

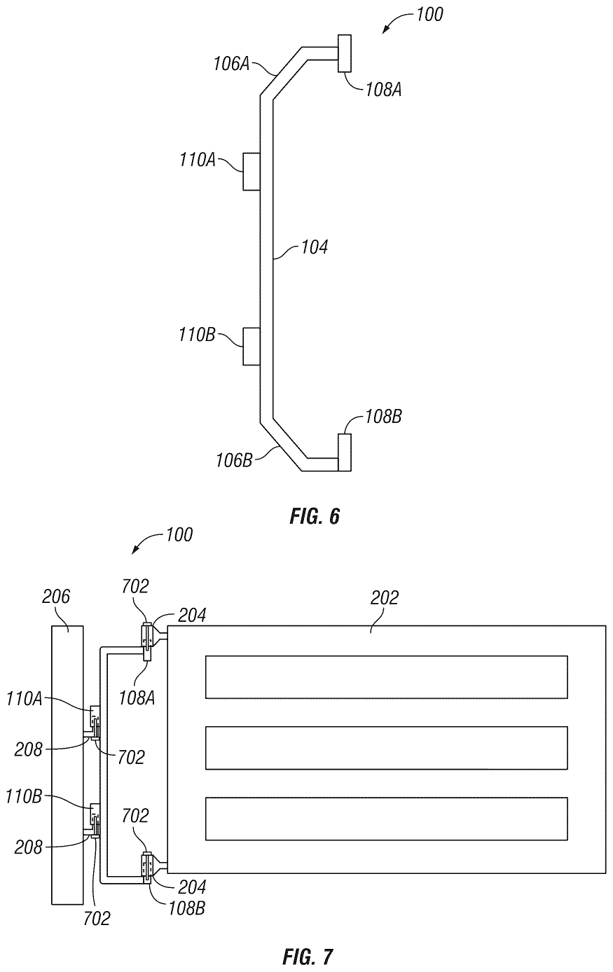

Referring to FIG. 1, illustrated is an isometric view of one embodiment of a gate hinge apparatus 100 designed and constructed in accordance with the disclosed principles. The gate hinge apparatus 100 may include a body 102 comprising a vertical member 104 and support arms 106A, 106B extending outwardly from the ends of the vertical member 104. In the non-limiting exemplary embodiment illustrated in FIG. 1, the body 102 may include a first support arm 106A and a second support arm 106B extending perpendicularly from the vertical member 104. The first support arm 106A may extend from the vertical member 104 in the same direction as the second support arm 106B. It will be understood by those of ordinary skill in the art that the body 102 may include additional support arms 106 extending from the vertical member 104. It will also be understood by those of ordinary skill in the art that the support arms 106 may extend from the vertical member 104 at a variety of angles. The support arms 106 may have a shorter length than the vertical member 104. Furthermore, the first support arm 106A may have the same length as the second support arm 106B. In the non-limiting exemplary embodiment illustrated in FIG. 1, the support arms 106 may be straight such that the entirety of each support arm 106 is perpendicular to the vertical member 104. However, differently shaped support arms 106 are within the scope of the claims. An exemplary embodiment of a gate hinge apparatus 100 with angled support arms 106 is described below with reference to FIG. 6. In various exemplary embodiments, the vertical member 104 and the support arms 106 may be formed from solid rods or hollow tubing having any cross-sectional shape such as, for example, square, round, rectangular, triangular, etc.

The gate hinge apparatus 100 may also include a plurality of hinge members disposed on the body 102 to removably and rotatably couple the gate hinge apparatus 100 to additional structures. The plurality of hinge members may include a first set of hinge members 108 disposed at the free ends of the support arms 106, substantially parallel to the vertical member 104. In the non-limiting exemplary embodiment illustrated in FIG. 1, the first set of hinge members 108 may be cylindrical hinge pins configured to engage hinge barrels disposed on a first structure (not shown). The first set of hinge members 108 may include a first hinge pin 108A and a second hinge pin 108B. The first hinge pin 108A may be disposed at the end of the first support arm 106A. The first hinge pin 108A may be positioned on the end of the first support arm 106A such that the length of the first hinge pin 108A extends substantially above the first support arm 106A. In an embodiment, the first hinge pin 108A may also be positioned on the end of the first support arm 106B such that the length of the first hinge pin 108A extends below the first support arm 106A. The second hinge pin 108B may be disposed at the end of the second support arm 106B. The second hinge pin 108B may be positioned on the end of the second support arm 106B such that the length of the second hinge pin 108B extends substantially above the second support arm 106B. In an embodiment, the second hinge pin 108B may be positioned on the end of the second support arm 106B such that a bottom edge of the second hinge pin 108B aligns with a bottom edge of the second support arm 106B. The first hinge pin 108A and the second hinge pin 108B may be aligned such that they are collinear.

The plurality of hinge members may also include a second set of hinge members 110 to rotatably couple the gate hinge apparatus 100 to additional structures. The second set of hinge members 110 may be disposed along the vertical member 104, opposite the support arms 106. In the non-limiting exemplary embodiment illustrated in FIG. 1, the second set of hinge members 110 may be hinge barrels. The second set of hinge members 110 may include a first hinge barrel 110A and a second hinge barrel 110B spaced apart from the first hinge barrel 110A, each defining an opening 112 with a substantially circular cross-section. The first hinge barrel 110A and the second hinge barrel 110B may be aligned such that the cylindrical openings 112 are collinear. The opening 112 may be substantially parallel with the vertical member 104. In an embodiment, the second set of hinge members 110 may optionally be slidably coupled to the vertical member 104 such that the positions of the second set of hinge members 110 along the vertical member 104 may be altered. As an example, the second set of hinge members 110 may include an adjustable collar (not shown) configured to engage the vertical member 104. One of ordinary skill in the art will recognize that the second set of hinge members 110 may include more than two hinge barrels disposed along the vertical member 104. One of ordinary skill in the art will also recognize that the hinge members 108, 110 are interchangeable. As a non-limiting example, the first set of hinge members 108 may be hinge barrels and the second set of hinge members 110 may be hinge pins. In another embodiment, each of the hinge members 108, 110 may be hinge pins. In yet another embodiment, each of the hinge members 108, 110 may be hinge barrels.

The gate hinge 100 may be formed from one or more of any suitable rigid materials, including but not limited to plastic, metal, composite materials, and the like. Other materials that provide the same utility are within the scope of the claims. Moreover, the components of the gate hinge apparatus 100 may be made by any suitable process, including but not limited to casting, molding, forming, forging, machining, and the like. In an embodiment, the body 102 and hinge members 108, 110 may be integrally formed such that the gate hinge apparatus 100 may be formed as a unitary component. Alternatively, the gate hinge apparatus 100 may be formed by joining the distinct body 102 and hinge members 108, 110 in accordance with the principles described herein.

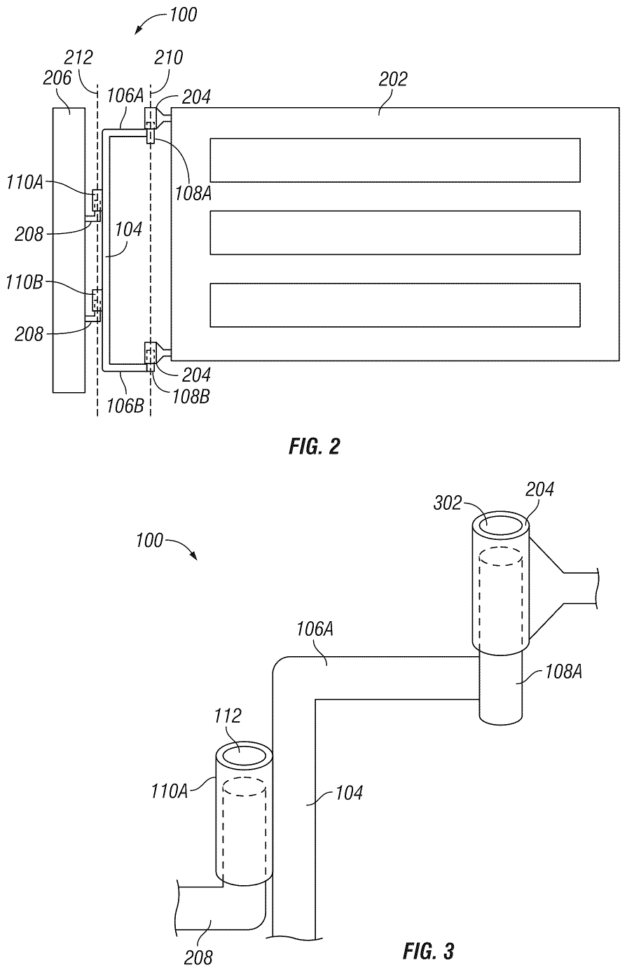

Referring to FIG. 2, illustrated is an isometric front view of an exemplary embodiment of a gate hinge apparatus 100 designed and constructed in accordance with the disclosed principles. As previously discussed, the apparatus 100 may be rotatably coupled to structures via the hinge members 108, 110. In the non-limiting exemplary embodiment illustrated in FIG. 2, the apparatus 100 may be rotatably coupled to a gate 202. The gate 202 may include a proximal end and a distal end, wherein the proximal end includes two gate hinge barrels 204 defining substantially cylindrical openings (not shown). As used herein, the term “proximal” means the end or part nearest the apparatus 100 and “distal” means the end or part furthest from the apparatus 100. The apparatus 100 may be rotatably coupled to the gate 202 via the first set of hinge members 110. More specifically, the apparatus 100 may be rotatably coupled to the gate 202 by inserting the first hinge pin 108A and the second hinge pin 108B into the openings of the gate hinge barrels 204. The first set of hinge members 108 may define a first axis of rotation 210 about which the gate hinge barrels 204, and therefore the gate 202, may be rotated. The first axis of rotation 210 may be aligned with the longitudinal axis of the first set of hinge members 108.

The gate hinge apparatus 100 may also be rotatably coupled to a support post 206. The support post 206 may include a proximal side and a distal side, wherein the proximal side includes two L-shaped support hinge pins 208 extending outwardly and upwardly from the support post 206 and the distal side may be coupled to a fence (not shown). The gate hinge apparatus 100 may be rotatably coupled to the support post 206 by inserting the support post hinge pins 208 into the openings 112 defined by the first hinge barrel 110A and second hinge barrel 110B. The second set of hinge members 110 may define a second axis of rotation 212 about which the gate hinge apparatus 100 and coupled gate 202 may be rotated. The second axis of rotation 212 may aligned with the longitudinal axis of the second set of hinge members 110 and may be parallel to the first axis of rotation 210. The second axis of rotation 212 is separated from the first axis of rotation 210 by the support arms 106.

As previously mentioned, cantilever farm gates are prone to structural issues due to their weight and extended length. The weight of the unsupported end of the gate can place excessive stress on the mechanisms by which the gate is attached to a support, which can result in misalignment and failure of the attachment mechanism. These problems are exacerbated by attachment mechanisms that fail to provide sufficient support to the upper portion of the gate, which can experience significant torsional force caused by the weight of the gate. It may therefore be advantageous to provide distributed support to the top and bottom ends of the gate. To this end, the sets of hinge members 108, 110 and the support arms 106 may provide distributed support to the top and bottom ends of the gate 202. As previously discussed, the apparatus 100 may include a first hinge pin 108A disposed at the end of the first support arm 106A and a second hinge pin 108B disposed at the end of the second support arm 106B. The first hinge pin 108A and the first support arm 106A may provide support to the upper portion of the gate 202 while the second hinge pin 108B and the second support arm 106B may provide support to the lower portion of the gate 202. Similarly, the first hinge barrel 110A may provide support to the upper portion of the gate 202 and the second hinge barrel 110B may provide support to the lower portion of the gate 202. By providing the same rotational support at both the top and bottom ends of the gate 202, the weight of the gate 202 may be distributed throughout the apparatus 100, thereby limiting the torsional force exerted on the upper attachment point.

Referring to FIG. 3, illustrated is an isometric front view of an exemplary embodiment of a gate hinge apparatus 100 designed and constructed in accordance with the disclosed principles. As previously described, the gate hinge apparatus 100 may be rotatably coupled to structures via the hinge mechanisms 108, 110. In the non-limiting exemplary embodiment illustrated in FIG. 3, the first hinge pin 108A may be coupled to one of the gate hinge barrels 204 by inserting the first hinge pin 108A into the opening 302 of the gate hinge barrel 204. Furthermore, the first hinge barrel 110A may receive one of the support hinge pins 208 through the opening 112 to couple the first hinge barrel 110A to one of the support hinge pins 208 of the support post 206.

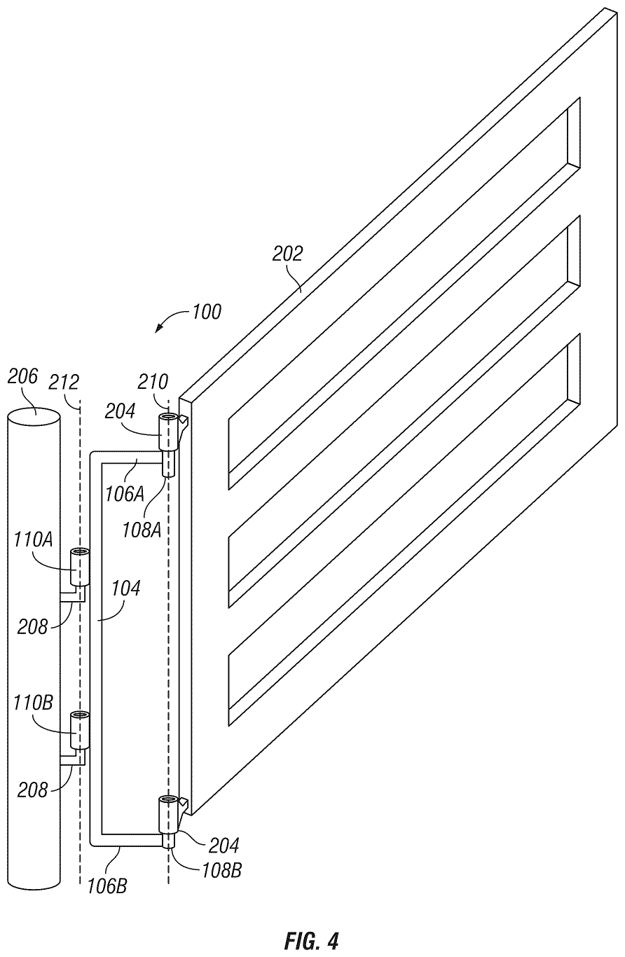

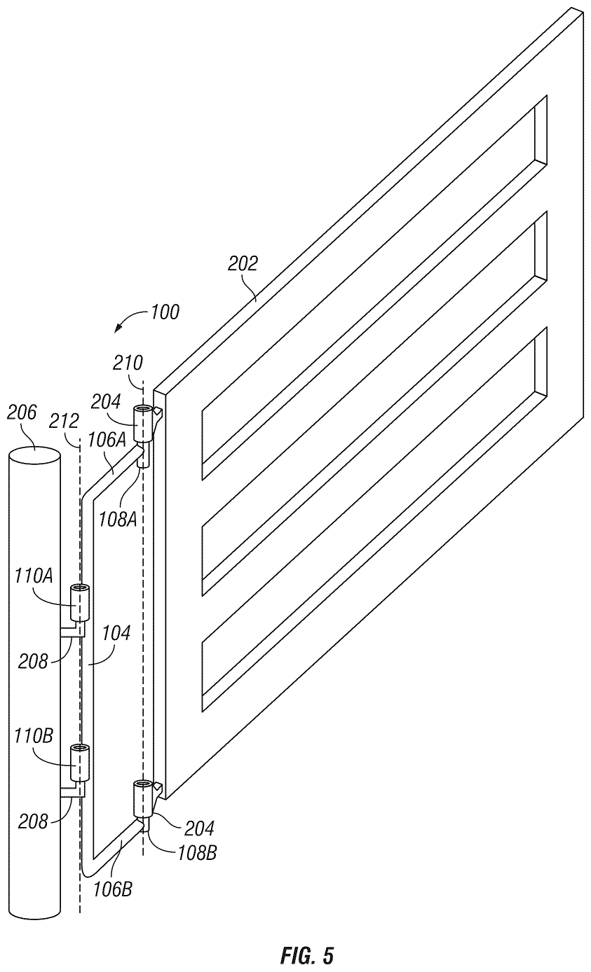

Referring to FIG. 4 and FIG. 5, illustrated are isometric front views of an exemplary embodiment of a gate hinge apparatus 100 designed and constructed in accordance with the disclosed principles. As previously discussed, the first set of hinge members 108 may define a first axis of rotation 210 and the second set of hinge members 110 may define a second axis of rotation 212. The gate 202 may be rotated about one or more of the first axis of rotation 210 and the second axis of rotation 212. In the non-limiting exemplary embodiment illustrated in FIG. 4, the gate 202 may be rotated about the first axis of rotation 210. That is, the gate hinge barrels 204 may be rotated about the longitudinal axis of the first set of hinge members 108. In the non-limiting exemplary embodiment illustrated in FIG. 5, the apparatus 100 and the coupled gate 202 may be rotated about the second axis of rotation 212. That is, the second hinge members 110 may be rotated about the longitudinal axis of the support hinge pins 208. The gate 202 may be rotated about the first axis of rotation 210 and the second axis of rotation 212 to varying degrees to open the gate 202 to a desired angle. By rotating the gate 202 about both the first axis of rotation 210 and the second axis of rotation 212, a user may fully rotate the gate 202 without obstruction from the support post 206. That is, a user may rotate the gate 202 such that the distal end of the gate 202 contacts the fence (not shown) attached to the distal side of the support post 206, thereby providing an unobstructed passageway through the fence.

Referring to FIG. 6, illustrated is an isometric front view of an exemplary embodiment of a gate hinge apparatus 100 designed and constructed in accordance with the disclosed principles. As previously mentioned, the gate hinge 100 may include a pair of support arms 106 to separate the first axis of rotation 210 from the second axis of rotation 212. In the non-limiting exemplary embodiment illustrated in FIG. 6, the support arms 106 may outwardly extend from the ends of the vertical member 104 at obtuse angles and may have angled shapes such that the end of each support arm 106 is perpendicular to the vertical member 104. It will be understood by one of ordinary skill in the arm that the shape of the support arms 106 is not limited to the examples illustrated herein, and that other shapes are within the scope of the claims.

Referring to FIG. 7, illustrated is an isometric front view of an exemplary embodiment of a gate hinge apparatus 100 designed and constructed in accordance with the disclosed principles. Livestock, especially larger animals like cows or horses, frequently knock farm gates off their hinges by exerting upward force to lift the gate off its hinges. It may therefore be desirable to secure the gate to the support and/or the mechanism by which the gate is attached to the support. In the non-limiting exemplary embodiment illustrated in FIG. 7, the gate hinge apparatus 100 may include a locking mechanism to removably secure the gate 202 to the apparatus 100. As a non-limiting example, the locking mechanism may include adjustable latches 702 disposed on first set of hinge members 108, wherein each latch 702 is configured to engage an upper edge of a gate hinge barrel 204 when the gate 202 is coupled to the apparatus 100. The locking mechanism may also include latches 702 disposed on the second set of hinge members 110, wherein each latch 702 is configured to engage a lower edge of a support hinge pin 208 when the support post 206 is coupled to the apparatus 100. With the latches 702 secured around the top of the gate hinge barrels 204 and bottom of the support hinge pins 208, exertion of an upward force will not lift the gate off the apparatus 100 or the apparatus 100 off the support post 206.

While this disclosure has been particularly shown and described with reference to preferred embodiments, it will be understood by those skilled in the pertinent field of art that various changes in form and detail may be made therein without departing from the spirit and scope of the disclosed principles. The inventors expect skilled artisans to employ such variations as appropriate, and the inventors intend the disclosed principles to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosed principles set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” or disclosed principles in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

I claim:

1. An apparatus comprising:
a first set of hinge elements configured to connect to a first structure;
a second set of hinge elements configured to connect to a second structure, wherein the second set of hinge elements is spaced apart from the first set of hinge elements; and
a body connecting the first set of hinge elements to the second set of hinge elements, wherein the body comprises a vertical member and support arms extending from the vertical member, wherein:
the first set of hinge elements defines a first axis of rotation, and
the second set of hinge elements defines a second axis of rotation, and wherein the second axis of rotation is different from the first axis of rotation.

2. The apparatus of claim 1, wherein the first set of hinge elements is disposed on the distal ends of the support arms, substantially parallel to the vertical member.

3. The apparatus of claim 1, wherein the first set of hinge elements comprises a first hinge element and a second hinge element spaced apart from the first hinge element.

4. The apparatus of claim 1, wherein the first hinge element rotatably supports an upper portion of the first structure and the second hinge element rotatably supports a lower portion of the first structure.

5. The apparatus of claim 1, wherein the second set of hinge elements is disposed on the vertical member, substantially parallel to the vertical member.

6. The apparatus of claim 5, wherein the second set of hinge elements is slidably coupled to the vertical member.

7. The apparatus of claim 1, wherein the second set of hinge elements comprises a third hinge element and a fourth hinge element spaced apart from the third hinge element.

8. The apparatus of claim 1, wherein the first set of hinge elements and the second set of hinge elements comprises one or more of hinge pins and hinge barrels.

9. The apparatus of claim 1, wherein the support arms extend perpendicularly from the vertical member.

10. The apparatus of claim 1, wherein the support arms are angled away from the vertical member.

11. The apparatus of claim 1, further comprising a locking mechanism configured to removably secure the apparatus to the first structure and second structure.

12. An assembly comprising:
a first structure;
a second structure; and
a gate hinge pivotally joining the first structure and the second structure, the gate hinge comprising:
a first set of hinge elements configured to connect to a first structure;
a second set of hinge elements configured to connect to a second structure, wherein the second set of hinge elements is spaced apart from the first set of hinge elements; and
a body connecting the first set of hinge elements to the second set of hinge elements, wherein the body comprises a vertical member and support arms extending from the vertical member, wherein:
the first set of hinge elements defines a first axis of rotation, and
the second set of hinge elements defines a second axis of rotation, and wherein the second axis of rotation is different from the first axis of rotation.

13. The assembly of claim 12, wherein the first structure is rotatable about both the first axis of rotation and the second axis of rotation and the second structure is static.

14. The assembly of claim 13, wherein the first structure is a gate and the second structure is a support post.

15. The assembly of claim 14, wherein the gate has a range of motion of about 350 degrees relative to the support post.

16. The assembly of claim 12, wherein the first set of hinge elements is rotatable about the second set of hinge elements.

17. The assembly of claim 12, wherein the first set of hinge elements is disposed on the distal ends of the support arms, substantially parallel to the vertical member and the second set of hinge elements is disposed on the vertical member, substantially parallel to the vertical member.

18. The assembly of claim 12, wherein the first set of hinge elements comprises a first hinge element and a second hinge element spaced apart from the first hinge element.

19. The assembly of claim 12, wherein the first hinge element rotatably supports an upper portion of the first structure and the second hinge element rotatably supports a lower portion of the first structure.

20. The assembly of claim 12, wherein the second set of hinge elements comprises a third hinge element and a fourth hinge element spaced apart from the third hinge element.
